(19) United States
(12) Patent Application Publication
(10) Pub. No.: US 2017/0242262 A1
(43) Pub. Date: Aug. 24, 2017

(54) Virtual Reality Headset

(71) Applicant: Smart Theater LLC, Van Nuys, CA (US)

(72) Inventors: Josh Fuchs, Granada Hills, CA (US); Joel Kort, Van Nuys, CA (US); Charles Seltzer, Sag Harbor, NY (US)

(21) Appl. No.: 15/436,347

(22) Filed: Feb. 17, 2017

Related U.S. Application Data
(60) Provisional application No. 62/297,674, filed on Feb. 19, 2016.

(51) Int. Cl. G02B 27/22; G06F 1/16; H04N 13/04; A45F 5/00

(52) U.S. Cl. CPC G02B 27/2228; A45F 5/00; G06F 1/163; H04N 13/044

(57) ABSTRACT

Virtual reality headsets capable of accommodating display devices of a plurality of shapes and sizes are provided herein. In a first embodiment, the virtual reality headset may include a buckle, a fastening engagement face, and an elastic strap with a fastening mechanism on a distal end. The elastic strap may be configured to be threaded through the buckle and the fastening mechanism may be configured to be detachably attached to the fastening mechanism engagement face to secure a display device to the virtual reality headset. In a second embodiment, the virtual reality headset may include a first fastening stud, a second fastening stud, and an elastic strap with a first line of holes and a second line of holes. The first and second lines of holes may be configured to be secured, respectively, to the first and second fastening studs to secure a display device to the virtual reality headset.

### CROSS-REFERENCE TO RELATED APPLICATIONS

The present application claims priority to U.S. Provisional Patent Application No. 62/297,674, filed Feb. 19, 2016, entitled “VIRTUAL REALITY HEADSET,” which is hereby incorporated by reference in its entirety.

### FIELD

Aspects described herein generally relate to virtual reality headsets. More specifically, aspects relate to virtual reality headsets capable of accommodating smart phones, smart tablets, and/or other display devices of a plurality of shapes and sizes.

### BACKGROUND

Virtual reality content is becoming increasingly popular and available to view on electronic devices such as smart phones and smart tablets. However, virtual reality headsets capable of accommodating a multitude of such devices of varying shape and size are absent from the market.

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed to virtual reality (VR) headsets capable of accommodating smart phones, smart tablets, and/or other display devices of a plurality of shapes and sizes, based on an identified need for virtual reality headsets capable of accommodating smart phones, smart tablets, and/or other display devices of a plurality of shapes and sizes.

A first aspect described herein provides a VR headset comprising a theater assembly. The theater assembly may include a display opening on a front face, a buckle rigidly attached to a top wall, and a strap attached to a bottom wall. The strap may include a fastening mechanism on a distal end and a fastening mechanism engagement face on a middle portion. The strap may be configured to be threaded through the buckle and the fastening mechanism on the distal end of the strap may be configured to be detachably attached to the fastening mechanism engagement face on the middle portion of the strap to secure a display device in the display opening on the front face of the theater assembly.

A second aspect described herein provides a VR headset comprising a theater assembly. The theater assembly may include a display opening on a front face, a buckle attached to a top wall, a strap attached to a bottom wall and including a fastening mechanism on a distal end, and a fastening mechanism engagement face on the bottom wall. The strap may be configured to be threaded through the buckle and the fastening mechanism on the distal end of the strap may be configured to be detachably attached to the fastening mechanism engagement face on the bottom wall to secure a display device in the display opening on the front face of the theater assembly.

A third aspect described herein provides a VR headset comprising a theater assembly. The theater assembly may include a display opening on a front face, a first buckle rigidly attached to a top wall, a second buckle rigidly attached to a right wall, a first strap attached to a bottom wall and including a first fastening mechanism on a distal end of the first strap, a second strap attached to a left wall and including a second fastening mechanism on a distal end of the second strap, a first fastening mechanism engagement face on the bottom wall, and a second fastening mechanism engagement face on the left wall. The first strap may be configured to be threaded through the first buckle, the second strap may be configured to be threaded through the second buckle, the first fastening mechanism on the distal end of the first strap may be configured to be detachably attached to the first fastening mechanism engagement face on the bottom wall of the theater assembly, and the second fastening mechanism on the distal end of the second strap may be configured to be detachably attached to the second fastening mechanism engagement face on the left wall of the theater assembly to secure a display device in the display opening on the front face of the theater assembly.

A fourth aspect described herein provides a VR headset comprising a theater assembly. The theater assembly may include a display opening on a front face, a first and second attachment protrusion on a top wall, and a strap attached to a bottom wall. The strap may include one or more fastening interfaces on a distal end, each of the one or more fastening interfaces including a first attachment hole and a second attachment hole. The strap may be configured to be extended over the top wall and a particular fastening interface of the one or more fastening interfaces may be aligned with the first and second attachment protrusions. The first attachment hole of the aligned fastening interface may be configured to be detachably attached to the first attachment protrusion and the second attachment hole of the aligned fastening interface may be configured to be detachably attached to the second attachment protrusion to secure a display device in the display opening on the front face of the theater assembly.

These features, along with many others, are discussed in greater detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1A illustrates a front prospective view of a first embodiment of the VR headset according to one or more aspects described herein.

FIG. 1B illustrates a top prospective view of the first embodiment of the VR headset according to one or more aspects described herein.

FIG. 1C illustrates a front view of the first embodiment of the VR headset according to one or more aspects described herein.

FIG. 1D illustrates a rear prospective view of the first embodiment of the VR headset according to one or more aspects described herein.

FIG. 1E illustrates a top view of the first embodiment of the VR headset according to one or more aspects described herein.

FIG. 2A illustrates a front prospective view of a second embodiment of the VR headset according to one or more aspects described herein.

FIG. 2B illustrates a top prospective view of the second embodiment of the VR headset according to one or more aspects described herein.

FIG. 2C illustrates a front view of the second embodiment of the VR headset according to one or more aspects described herein.

FIG. 2D illustrates a rear perspective view of the second embodiment of the VR headset according to one or more aspects described herein.

FIG. 2E illustrates a top view of the second embodiment of the VR headset according to one or more aspects described herein.

FIG. 3A depicts a rendering of a VR headset to illustrate button control interfaces and a spring-loaded capacitive trigger with a soft conductive silicone tip in a state in which a display device is unfastened according to one or more aspects described herein.

FIG. 3B depicts a rending of a VR headset to illustrate button control interfaces and a spring-loaded capacitive trigger with a soft conductive silicone tip in a state in which a display device is fastened according to one or more aspects described herein.

FIG. 4 depicts a rendering of a top view of a VR headset according to one or more aspects described herein.

FIG. 5 depicts a rendering of a front view of a VR headset for retail according to one or more aspects described herein.

### DETAILED DESCRIPTION

In the following description of the various examples and components of this disclosure, reference is made to the accompanying drawings, which form a part hereof, and in which are shown by way of illustration various example structures in which aspects of the disclosure may be practiced. It is to be understood that other structures may be utilized and that structural and functional modifications may be made from the specifically described structures without departing from the scope of the present disclosure.

Also, while the terms “top,” “bottom,” “front,” “back,” “side,” “rear,” “upward,” “downward,” “right,” “left,” and the like may be used in this specification to describe various example features and elements of the VR headset, these terms are used herein as a matter of convenience, e.g., based on the example orientations shown in the figures or the orientation during typical use. Additionally, the term “plurality,” as used herein, indicates any number greater than one, either disjunctively or conjunctively, as necessary, up to an infinite number. Nothing in this specification should be construed as requiring a specific three dimensional orientation of structures in order to fall within the scope of this invention. Also, the reader is advised that the attached drawings are not necessarily drawn to scale.

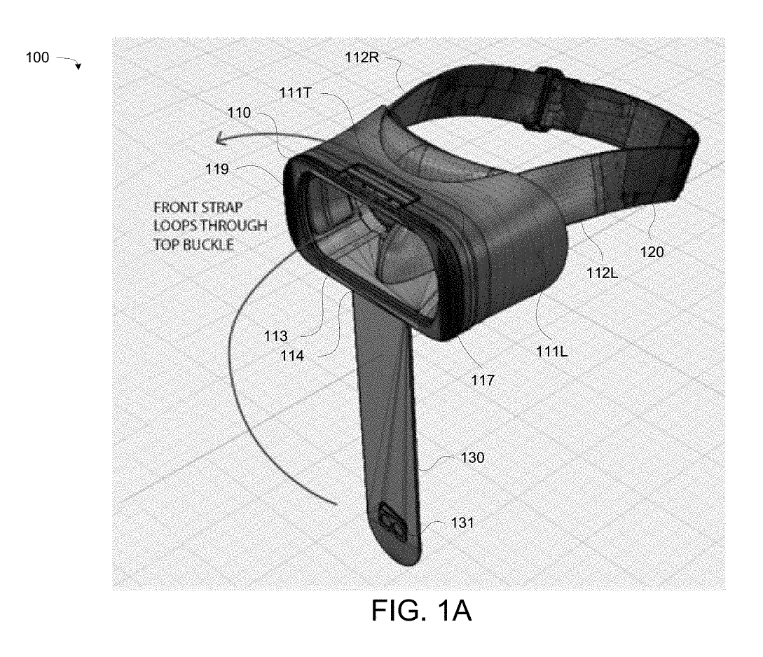

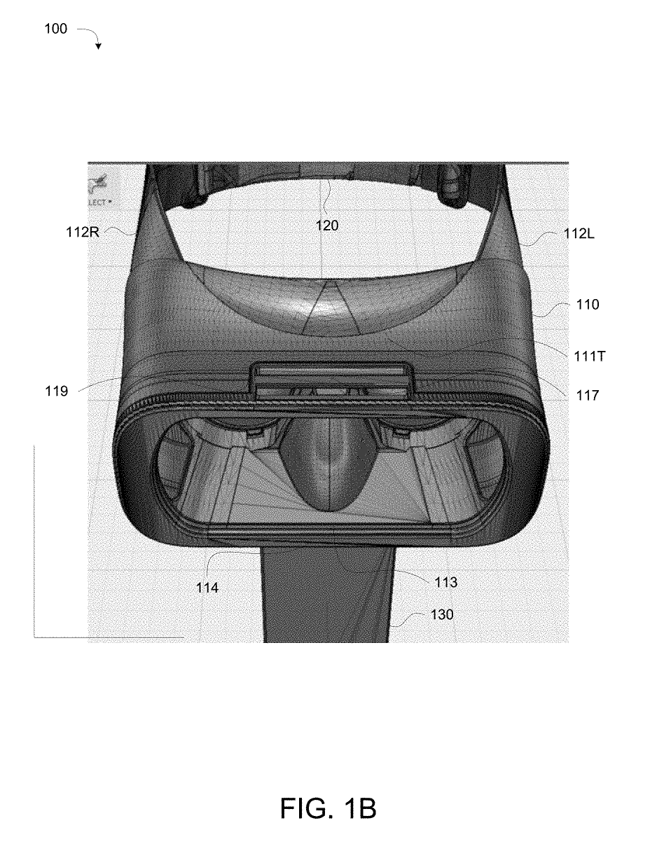

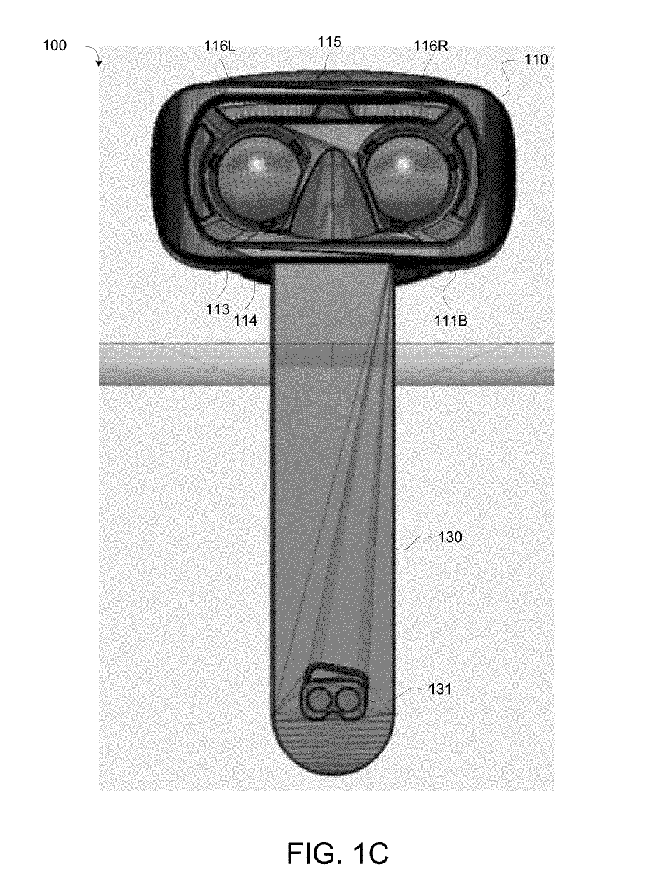

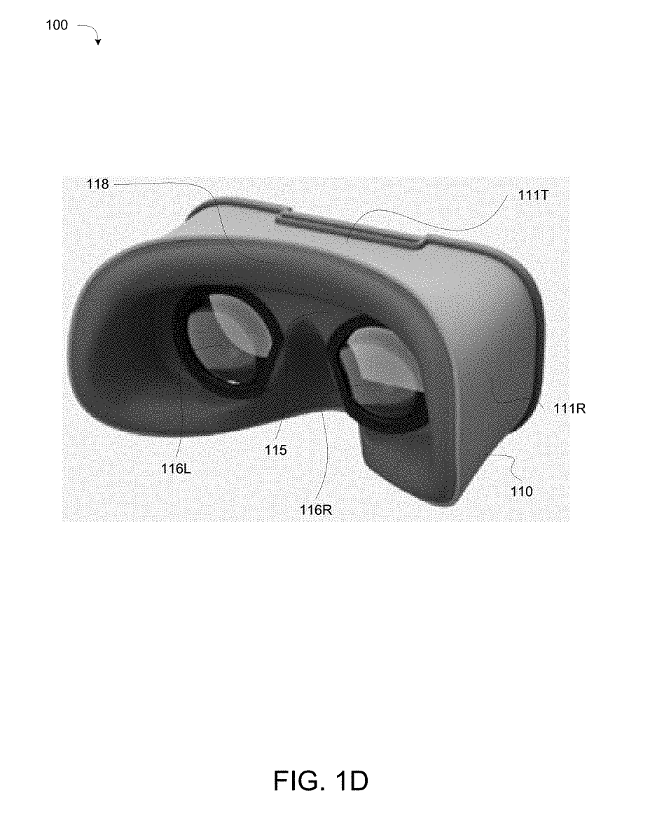

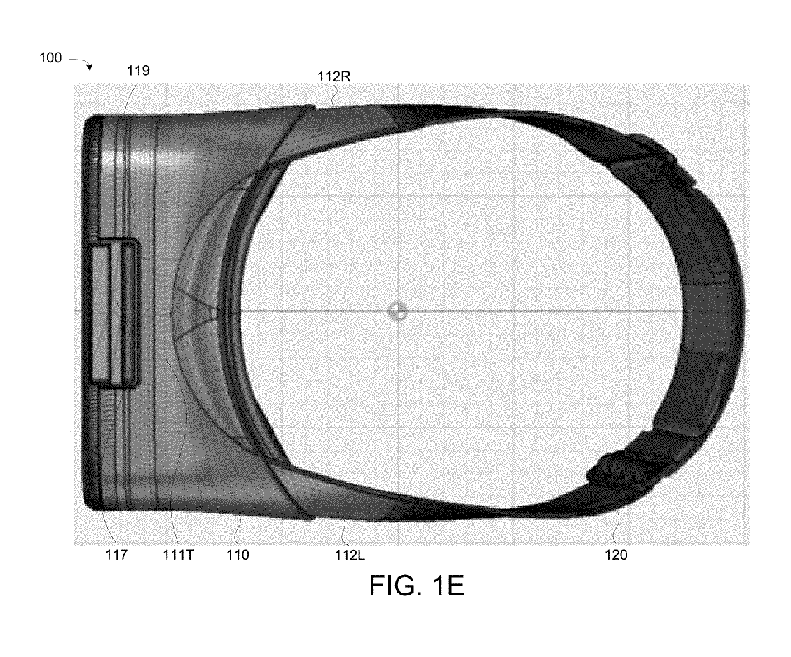

FIGS. 1A-1E depict a first embodiment of a VR headset (e.g., VR headset 100). The VR headset 100 may be a head-mounted device (“HMD”) and may include a theater assembly 110, a user engagement strap 120, and a display device fastening strap 130. As will be described in detail below, such components, in combination with additional structures described herein, may allow for VR headset 100 to accommodate smart phones, smart tablets, and/or other display devices of a plurality of shapes and sizes in providing a virtual reality experience to a user.

Referring to FIG. 1A, the theater assembly 110 of VR headset 100 may be a rigid construct made from one or more of plastic, rubber, metal, cardboard, and wood. The front face of theater assembly 110 may include a display opening 113, which may provide a viewport through which a user of VR headset 100 may view a display of a display device (e.g., smart phone, smart tablet, and the like) and participate in a virtual reality simulation.

The display opening 113 may include a tapered contact surface 114 configured to interface with a perimeter of a display device. The tapered contact surface 114 may have tapered distal ends on a right and left side in order to accommodate display devices of varying dimensions, as well as to provide a retaining force to a display device in a state in which the display device is fastened to display opening 113. In some instances, the tapered contact surface 114 may be affixed with an inlaid piece of depressible material such as foam, rubber, and the like which may keep the display device in place, prevent slipping, and prevent the screen of the display device from being scratched by the theater assembly 110. Furthermore, the tapered contact surface 114 and the inlaid depressible material affixed thereto may enable the VR headset 100 to be able to accommodate a display device with a case attached.

In reference to FIG. 1B, the theater assembly 110 may include a fixture interface 119 attached to the top wall 111T of the theater assembly 110. In some instances, the fixture interface 119 may include a buckle 117. As will be discussed in further detail below, the display device fastening strap 130 may be configured to be threaded through (e.g., under and over) buckle 117 to secure a display device to the tapered contact surface 114 of the display opening 113.

As shown in FIG. 1C, at an interior portion, the theater assembly 110 may include a right lens 116R and a left lens 116L mounted on an adjustable housing 115 that may be positioned a changeable distance away from the display opening 113. The right lens 116R and left lens 116L may be aspherical bi-convex lenses through which a user may observe stereoscopic content from a display device. The adjustable housing 115 may be a mechanical or electromechanical apparatus configured to allow the user to independently adjust the inter-pupillary distance (“IPD”) of the right lens 116R and left lens 116L for visual focus and clarity. Through actuation, the adjustable housing 115 may cause the lenses to move along one or more of a first axis (e.g., front to back), second axis (e.g., left to right), and third axis (e.g., up and down) to align the centers of the lenses with the centers of the user's pupils. This focal adjustment may allow the user to discard a visual aide such as glasses or while participating in a virtual reality simulation provided by VR headset 100.

In some instances, there may be a first control interface for the adjustable housing 115 corresponding to the right lens 116R on a right wall 111R of the theater assembly 110 and a second control interface for the adjustable housing 115 corresponding to the left lens 116L on a left wall 111L of the theater assembly 110. In other instances, the theater assembly 110 may include a single control interface on either the right or left wall that may control movement of either the right lens 116R or left lens 116L through actuation of the adjustable housing 115 based on a user selection. The first and second control interfaces may be capacitance-based or button interfaces that enable a user to activate a motor system of the adjustable housing 115. Alternatively, the first control interface and the second control interface may be positioned on top wall 111T of the theater assembly 110.

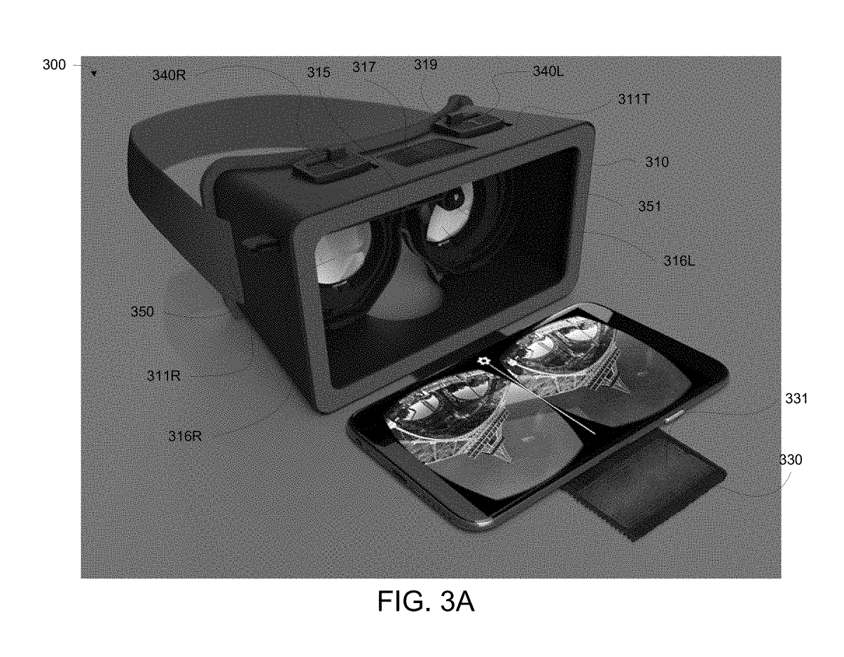

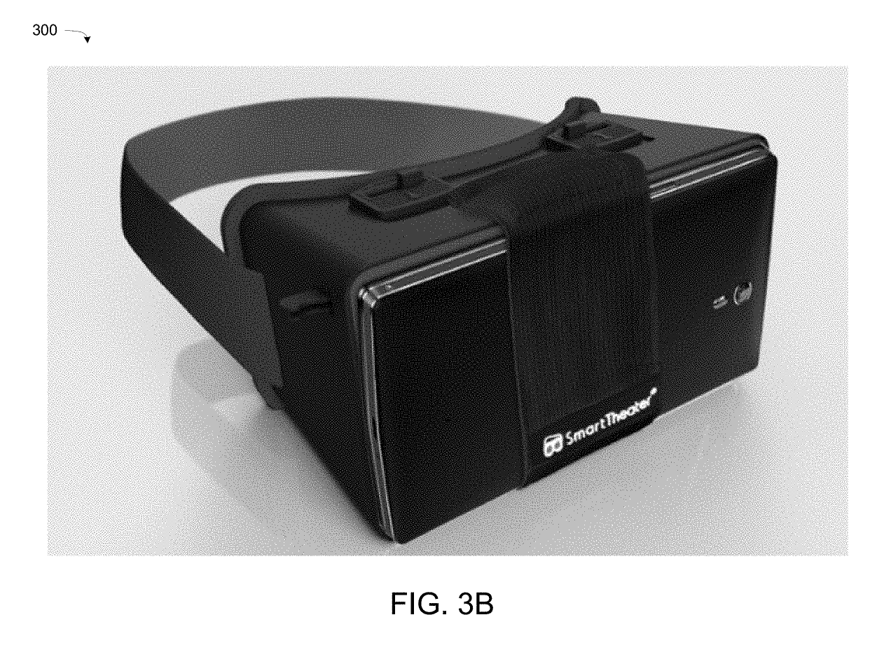

For example, in reference to FIG. 3A and in regard to VR headset 300, the first control interface 340R for the adjustable housing 315 corresponding to the right lens 316R and the second control interface 340L for the adjustable housing 315 corresponding to the left lens 316L may be positioned on top wall 311T of theater assembly 310. In this instance, the first control interface 340R and the second control interface 340L may be button interfaces with buttons corresponding to movements along the first, second, and third axis.

Referring to FIG. 1D, the theater assembly 110 may include an orbital contact surface 118 at a rear portion. The orbital contact surface 118 may be configured to engage with an orbital area of a user in a state in which the VR headset is secured to the user's head. In some instances, the orbital contact surface 118 may be manufactured from a composite material consisting of at least ethylene vinyl acetate (EVA) foam and an anti-microbial additive to provide for increased user comfort and reduced bacterial growth.

In reference to FIGS. 1A and 1E, the VR headset 100 may further include a user engagement strap 120, which may be an adjustable elastic head-strap that may use a plastic buckle to secure the strap at the desired length in order to fasten the VR headset to the head of a user. The engagement strap 120 may be removeably attached to a right user engagement strap attachment face 112R and a left engagement strap attachment face 112L of theater assembly 110. The ends of the user engagement strap 120 may be fitted through slots on the right user engagement strap attachment face 112R and left engagement strap attachment face 112L and may be sewn such that they lock into the right user engagement strap attachment face 112R and left engagement strap attachment face 112L to prevent light from entering virtual simulation environment. In some instances, the user engagement strap 120 may be a one-size-fits-all elastic strap and may be configured to secure the VR headset 100 to a head of a user of any of a plurality of sizes.

Additionally, the theater assembly 110 of the VR headset 100 may contain a spring-loaded capacitive trigger on an interior/exterior portion of the theater assembly 110 of the VR headset 100. The spring-loaded capacitive trigger may have a first end constructed from electrically conductive plastic and a second end constructed with a soft conductive silicone tip. The trigger mechanism may function as a capacitive extension of the user's fingertip such that the current in the finger may be transmitted through the trigger to the silicone tip which presses on the screen surface of the display device in order to activate the capacitive input capability of the display device in a manner similar to that of a finger tap on the screen. This function may be used in various ways by programmed content being played on the display device. The trigger may be spring-loaded so that it returns to its initial position after being toggled.

For example, referring to FIG. 3A, a spring-loaded capacitive trigger 350 may have a first end positioned on right wall 311R of theater assembly 310 and a second end (e.g., soft conductive silicone tip 351) on an interior portion of theater assembly 310. The first end of the spring-loaded capacitive trigger 350 may be configured to receive a capacitive touch input from a user and subsequently translate the touch input provided by the user to the soft conductive silicone tip 351, which may be configured to further transmit the user input to the display device. Upon receiving the touch input, the spring-loaded capacitive trigger 350 may displace and subsequently return to position after being toggled.

Referring to again to FIG. 1A, the VR headset 100 may further include a display device fastening strap 130, which may be an elastic strap fastened to a bottom wall 111B of theater assembly 110. The display device fastening strap 130 may be made of one or more of nylon, polyester, spandex, vinyl, velvet, denim, cotton, knit elastic, braided elastic, woven elastic, fold-over elastic, and the like. The display device fastening strap 130 may be configured to elongate in relation to a size (e.g., length, width, and/or thickness) of the display device in a state in which the display device is secured in the display opening 113 by the display device fastening strap 130. Additionally, the display device fastening strap 130 may reduce the total weight of VR headset 100 and increase heat dissipation to prevent overheating of a display device in a state in which a display device is attached to VR headset 100 by display device fastening strap 130.

The display device fastening strap 130 may include a fastening mechanism 131 on a distal end of the display device fastening strap 130. In some instances, the display device fastening strap 130 may further include a fastening mechanism engagement face on a middle portion of the strap. Additionally and/or alternatively, the fastening mechanism engagement face may be attached to the bottom wall 111B of theater assembly 110. The display device fastening strap 130 may be used to secure a display device to the tapered contact surface 114 of the display opening 113.

For example, a display device of any of a range of dimensions may be placed against the tapered contact surface 114 of display opening 113. The display device fastening strap 130 may be configured to be extended upwardly and threaded around the buckle 117. In such a state, a front surface of the display device fastening strap 130 may be in contact with a back portion of the display device. Subsequently, the display device fastening strap 130 may be configured to be extended downwardly. In doing so, the display device fastening strap 130 may become taut and thereby provide and/or increase an inward retaining force applied to the back portion of the display device. Such a force in combination with the frictive force provided by the tapered contact surface 114 may cause the display device to be fastened to the VR headset 100. After the display device is determined to be secured against the tapered contact surface 114 by the inward retaining force applied by the display device fastening strap 130, the fastening mechanism 131 on the distal end of the display device fastening strap 130 may be detachably attached to either the fastening mechanism engagement face on a middle portion of the display device fastening strap 130 or the fastening mechanism engagement face on the bottom wall 111B of the theater assembly 110. The display device fastening strap 130 may be configured to elongate in relation to a size of the display device in a state in which the display device is secured in the display opening. As such, the display device fastening strap 130 may be configured to accommodate a display device even when the display device is housed within its own protective case.

In some instances, the fastening mechanism 131 may be a linear fabric strip comprising a plurality of hooking elements (e.g., hook fastening interface) and the fastening mechanism engagement face, either on the middle portion of the strap 130 or the bottom wall 111B of the theater assembly 110, may be a linear fabric strip comprising a plurality of loop elements (e.g., loop fastening interface) configured to detachably attach to the linear fabric strip comprising the plurality of hooking elements . In other instances, the fastening mechanism 131 may be a first VELCRO strip and the fastening mechanism engagement face, either on the middle portion of the strap 130 or the bottom wall 111B of the theater assembly 110, may be a second VELCRO strip configured to detachably attach to the first VELCRO strip. Alternatively, the fastening mechanism 131 may be one or more snap clips and the fastening mechanism engagement face, either on the middle portion of the strap 130 or the bottom wall 111B, may be one or more snap clip receivers. In some cases, the fastening mechanism 131 may be one or more magnets and the fastening mechanism engagement face, either on the middle portion of the strap 130 or the bottom wall 111B, may be a one or more magnets oriented at an opposite polarity to the one or more magnets of the fastening mechanism 131. In some cases, the fastening mechanism 131 may be one or more magnets and the fastening mechanism engagement face, either on the middle portion of the strap 130 or the bottom wall 111B, may be a one or more metal fixtures configured to attract the one or more magnets of the fastening mechanism 131. Conversely, the fastening mechanism 131 may be one or more metal fixtures and the fastening mechanism engagement face, either on the middle portion of the strap 130 or the bottom wall 111B, may be a one or more magnets configured to be attracted to the one or more metal fixtures of the fastening mechanism 131.

Additionally and/or alternatively, the theater assembly 110 may further include a second fixture interface including a second buckle attached to right wall 111R or left wall 111L in a manner similar to that of buckle 117, and a second display device fastening strap attached to either the right wall 111R or left wall 111L, but on an opposite wall to that of the second buckle, in a manner similar to that of display device fastening strap 130. The second display device fastening strap may include a fastening mechanism at a distal portion and, in some instances, may further include a fastening mechanism engagement face on a middle portion of the strap. Additionally and/or alternatively, the fastening mechanism engagement face may be attached to the right wall 111R or left wall 111L in relation to wall on which the second display device fastening strap is attached.

The second display device fastening strap may be configured to be extended leftwardly/rightwardly and threaded around the second buckle. Subsequently, the second display device fastening strap may be configured to be extended rightwardly/leftwardly in a direction opposite that of the initial movement. In doing so, the second display device fastening strap may become taut and thereby provide and/or increase an inward retaining force applied to the back portion of the display device. The fastening mechanism on the distal end of the second display device fastening strap may be detachably attached to either the fastening mechanism engagement face on a middle portion of the second display device fastening strap or the fastening mechanism engagement face on the left wall 111L or right wall 111R of the theater assembly 110.

In some instances, the second display device fastening strap may be used to further secure a display device to the tapered contact surface 114 of the display opening 113 in addition to the display device fastening strap 130. In other instances, the second display device fastening strap may be used in place of the display device fastening strap 130. Furthermore, the fastening mechanism and fastening mechanism engagement face as related to the second display device fastening strap may be similar to those described above in regard to display device fastening strap 130.

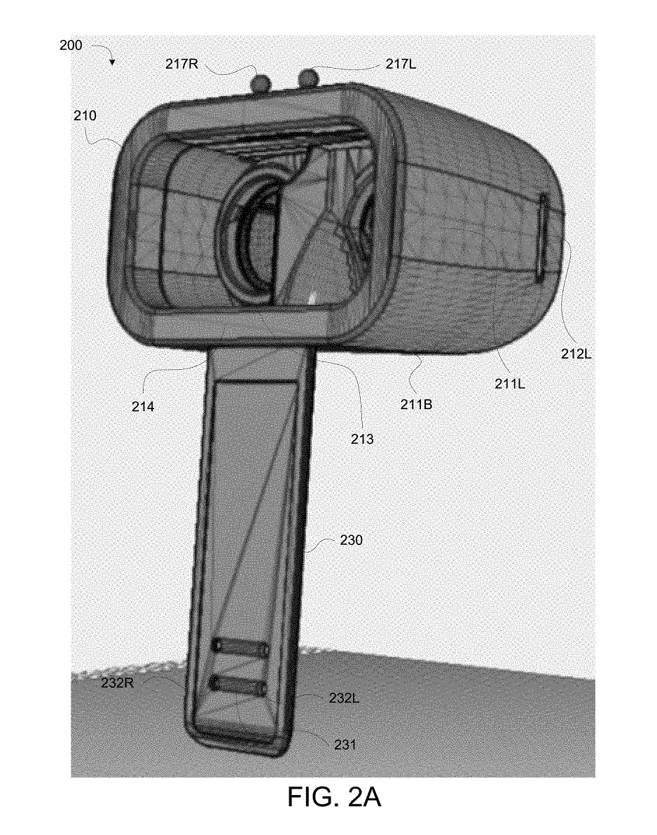

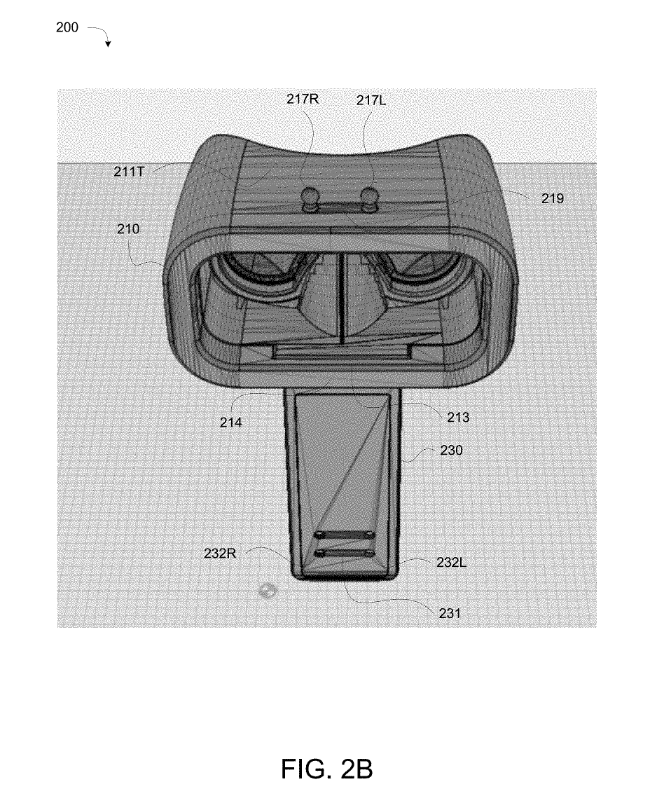

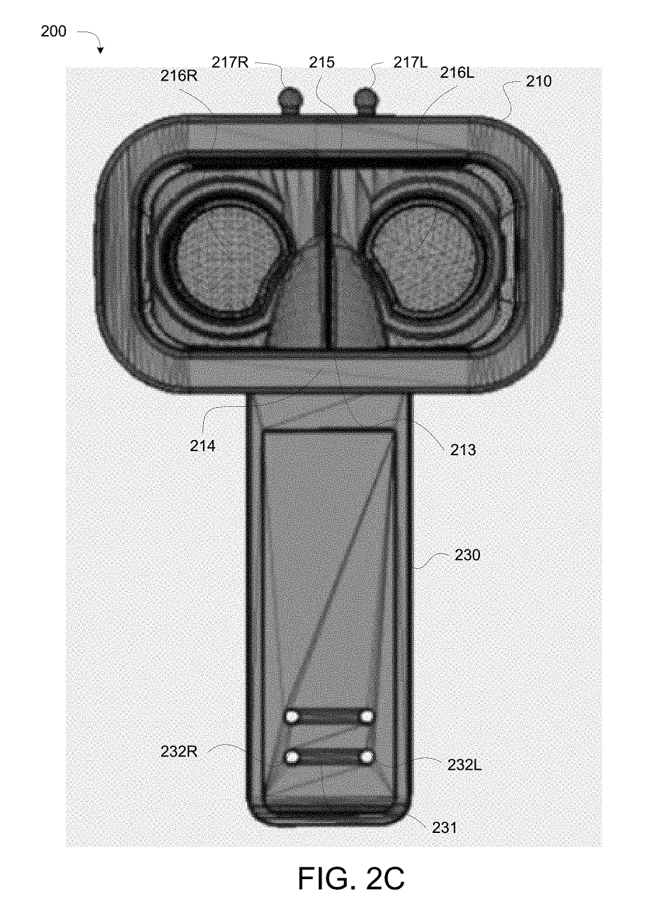

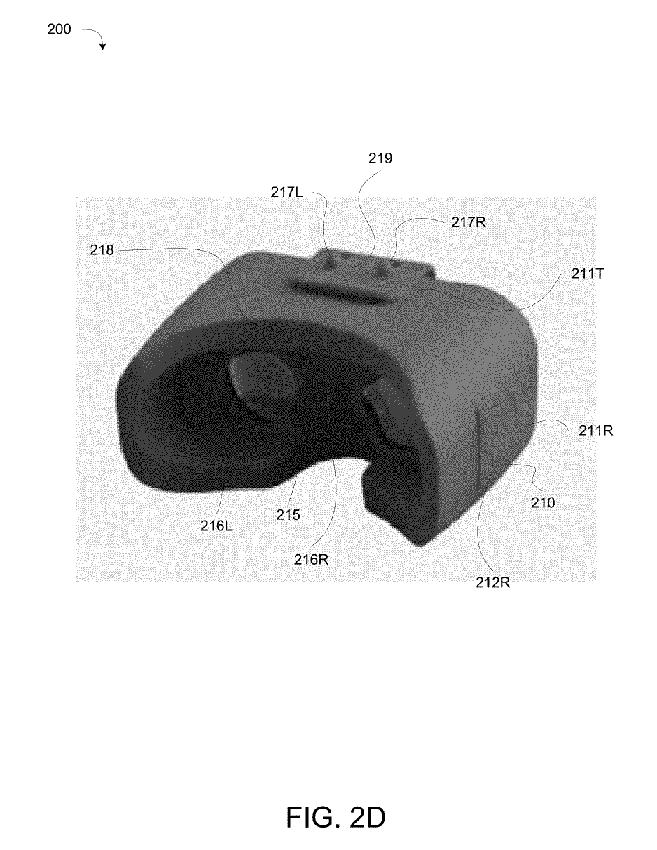

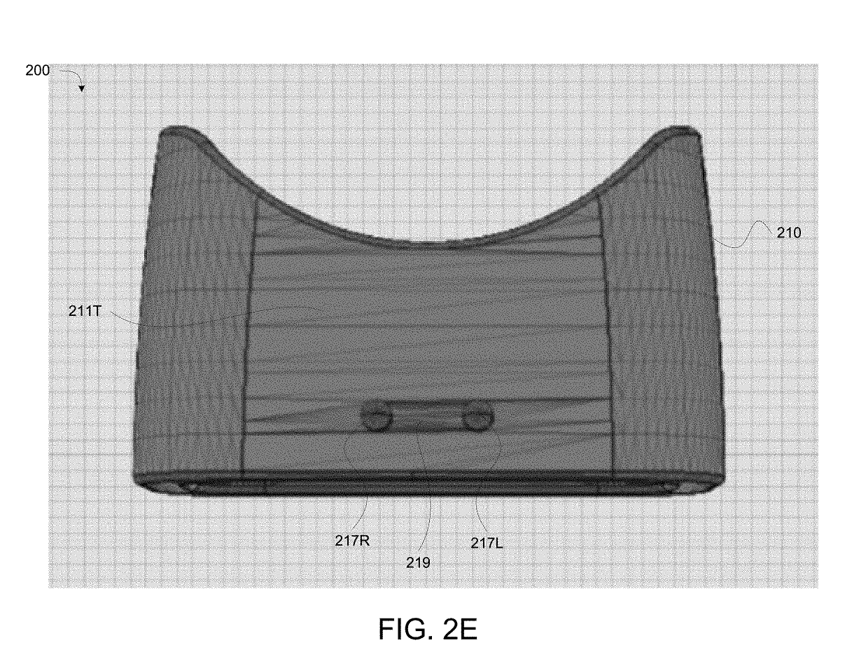

FIGS. 2A-2E depict a second embodiment of a VR headset (e.g., VR headset 200). In the second embodiment, the VR headset 200 may be of a similar construction to the above example, where like reference numerals represent features having similar functionality. However, as shown in FIGS. 2A-2E, in the theater assembly 210 of the VR headset 200, the fixture interface may include a first attachment protrusion 217R and a second attachment protrusion 217L. Furthermore, the display device fastening strap 230 may include one or more fastening mechanisms 231 on a distal end of the strap 230 and the one or more fastening mechanisms 231 may each include a first attachment hole 232R and a second attachment hole 232L.

In some instances, the fixture interface 219 of the theater assembly 210 may include one or more attachment protrusions and the one or more fastening mechanisms 231 of the display device fastening strap 230 may include a number of attachment holes corresponding to the number of the one or more attachment protrusions. For example, if there is one attachment protrusions, then there may be one attachment hole, if there are three attachment protrusions, then there may be three attachment holes, and so on.

The display device fastening strap 230 may be configured to secure a display device to the display opening 213. For example, a display device of any of a range of dimensions may be placed against the tapered contact surface 214 of display opening 213. The display device fastening strap 230 may be configured to be extended over the top wall 211T and a particular fastening mechanism 231 from the one or more fastening mechanisms may be aligned with the first attachment protrusion 217R and second attachment protrusion 217L. The first attachment hole 232R of the aligned fastening interface 231 may be configured to be detachably attached to the first attachment protrusion 217R and the second attachment hole 232L of the aligned fastening interface 231 may be configured to be detachably attached to the second attachment protrusion 217R to secure the display device in the display opening 213 on the front face of the theater assembly 210.

Alternatively, the fixture interface 219 of the top wall 211T of the theatre assembly 210 may include a fastening mechanism engagement face. In some instances, the fastening mechanism 231 may be a hook fastening interface and the fastening mechanism engagement face may be a loop fastening interface configured to detachably attach to the hook fastening interface. In other instances, the fastening mechanism 231 may be a first VELCRO strip and the fastening mechanism engagement face may be a second VELCRO strip configured to detachably attach to the first VELCRO strip. Alternatively, the fastening mechanism 231 may be one or more snap clips and the fastening mechanism engagement face, may be one or more snap clip receivers. In some cases, the fastening mechanism 231 may be one or more magnets and the fastening mechanism engagement face may be a one or more magnets oriented at an opposite polarity to the one or more magnets of the fastening mechanism. In some cases, the fastening mechanism 231 may be one or more magnets and the fastening mechanism engagement face may be a one or more metal fixtures configured to attract the one or more magnets of the fastening mechanism. Conversely, the fastening mechanism 231 may be one or more metal fixtures and the fastening mechanism engagement face may be a one or more magnets configured to be attracted to the one or more metal fixtures of the fastening mechanism.

For example, in reference to FIG. 3A, the fastening mechanism 331 of the display device fastening strap 330 may be a hook fastening interface. The fixture interface 319 of the top wall 311T of the theater assembly 310 may include a fastening mechanism engagement face 317, which may be a loop fastening interface. The hook fastening interface (e.g., fastening mechanism 331) and the loop fastening interface (e.g., fastening mechanism engagement face 317) may be configured to detachably attach to each other.

FIG. 3B depicts a rending of a VR headset to illustrate button control interfaces and a spring-loaded capacitive trigger with a soft conductive silicone tip in a state in which a display device is fastened according to one or more aspects described herein.

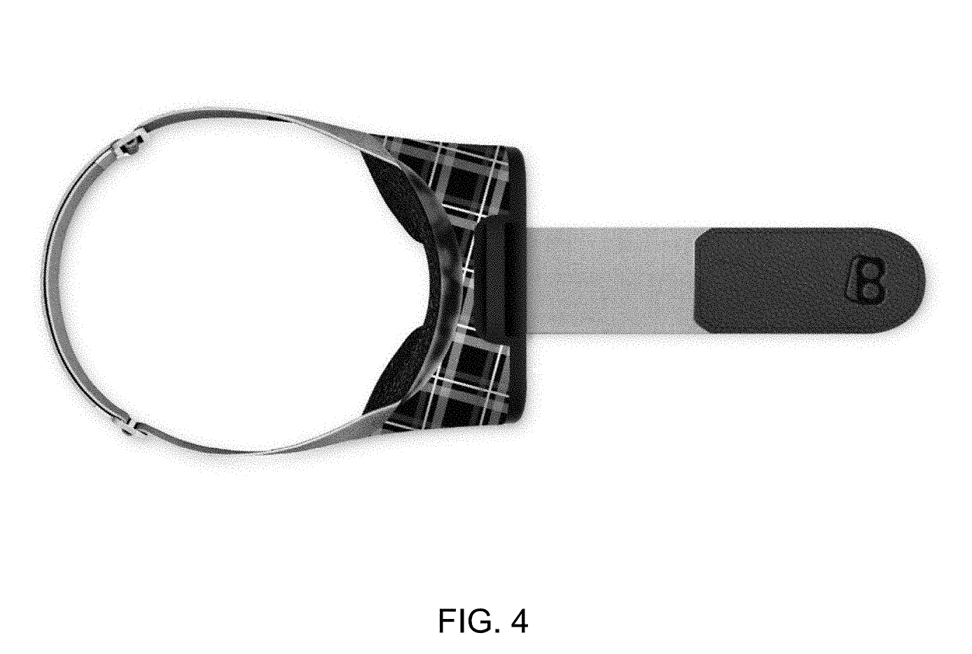

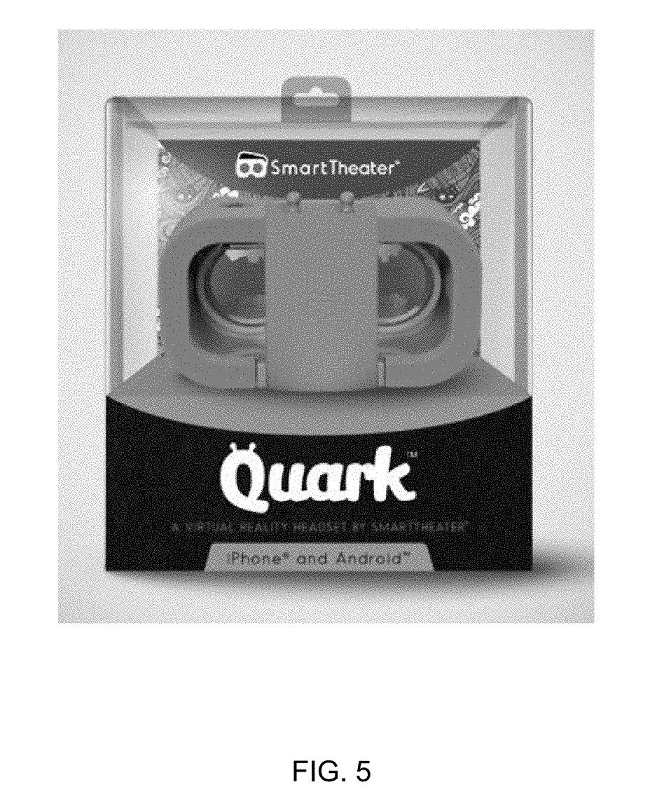

FIGS. 4 and 5 respectively depict renderings of a top view of a VR headset and a front view of a VR headset for retail according to one or more aspects described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A virtual reality (VR) headset comprising:
a theater assembly including:
a display opening on a front face of the theater assembly;
a fixture interface attached to a top wall of the theater assembly; and
a strap attached to a bottom wall of the theater assembly, the strap including:
a fastening mechanism on a distal end of the strap; and
wherein the strap is configured to engage with the fixture interface to secure a display device in the display opening on the front face of the theater assembly.

2. The VR headset of claim 1, wherein the fixture interface comprises a buckle rigidly attached to the top wall of the theater assembly, wherein the strap further comprises a fastening mechanism engagement face on a middle portion of the strap, and wherein the strap is configured to be threaded through the buckle, and the fastening mechanism on the distal end of the strap is configured to be detachably attached to the fastening mechanism engagement face on the middle portion of the strap to secure the display device in the display opening on the front face of the theater assembly.

3. The VR headset of claim 2, wherein the fastening mechanism is a hook fastening interface and the fastening mechanism engagement face is a loop fastening interface.

4. The VR headset of claim 2, wherein the fastening mechanism is a first magnet and the fastening mechanism engagement face is a second magnet of an opposite polarity of that of the first magnet.

5. The VR headset of claim 1, wherein the fixture interface includes a fastening mechanism engagement face and wherein the strap is configured to be extended over the top wall of the theater assembly and the fastening mechanism on the distal end of the strap is configured to be detachably attached to the fastening mechanism engagement face to secure the display device in the display opening on the front face of the theater assembly.

6. The VR headset of claim 5, wherein the fastening mechanism is a hook fastening interface and the fastening mechanism engagement face is a loop fastening interface.

7. The VR headset of claim 5, wherein the fastening mechanism is a first magnet and the fastening mechanism engagement face is a second magnet of an opposite polarity of that of the first magnet.

8. The VR headset of claim 1, wherein the fixture interface includes one or more attachment protrusions, wherein the strap includes one or more fastening mechanisms, each of the one or more fastening mechanisms including a number of attachment holes corresponding to a number of the one or more attachment protrusions, and wherein the strap is configured to be extended over the top wall of the theater assembly and the number of attachment holes corresponding to the number of the one or more attachment protrusions are configured to be detachably attached to the number of the one or more attachment protrusions to secure the display device in the display opening on the front face of the theater assembly.

9. The VR headset of claim 8, the fixture interface includes a first attachment protrusion and a second attachment protrusion, wherein the strap includes one or more fastening mechanisms, each of the one or more fastening mechanisms including a first attachment hole and a second attachment hole, and wherein the strap is configured to be extended over the top wall of the theater assembly and the first attachment hole is configured to be detachably attached to the first attachment protrusion and the second attachment hole is configured to be detachably attached to the second attachment protrusion to secure the display device in the display opening on the front face of the theater assembly.

10. The VR headset of claim 1, wherein the display opening includes a tapered contact surface configured to interface with the display device, and wherein the tapered contact surface includes an inlaid depressible material to frictionally engage the display device in a state in which the display device is secured in the display opening.

11. The VR headset of claim 1, wherein the strap is an elastic strap that is configured to elongate in relation to a size of the display device in a state in which the display device is secured in the display opening.

12. The VR headset of claim 11, wherein the theater assembly further includes:
an adjustable housing;
a first lens and a second lens mounted on the adjustable housing;
a first control interface on the top wall of the theater assembly; and
a second control interface on the top wall of the theater assembly,
wherein the first control interface is configured to actuate the adjustable housing to displace the first lens along a first, second, and third axis, the second control interface is configured to actuate the adjustable housing to displace the second lens along the first, second, and third axis, and wherein a displacement of the first lens and the second lens is independent.

13. The VR headset of claim 1, further comprising:
an elastic strap fastened to a right user engagement strap attachment face and a left user engagement strap attachment face of the theater assembly, wherein the elastic strap is configured to secure the VR headset to a head of a user of any of a plurality of sizes.

14. The VR headset of claim 1, wherein the theater assembly further includes:
an orbital contact surface configured to engage with an orbital area of a user in a state in which the VR headset is secured to a head of the user, wherein the orbital contact surface is manufactured from ethylene vinyl acetate (EVA) foam including an anti-microbial additive.

15. The VR headset of claim 1, wherein the theater assembly further includes:
a spring-loaded capacitive trigger on an interior portion of the theater assembly, wherein the spring-loaded capacitive trigger includes a silicone tip and is manufactured from electrically conductive plastic, and wherein in a state in which the display device is secured in the display opening of the theater assembly, the silicone tip is configured to engage with the display device.

16. The VR headset of claim 1, wherein the theater assembly further includes:
a second fixture interface attached to a right wall of the theater assembly; and
a second strap attached to a left wall of the theater assembly, the second strap including a second fastening mechanism on a distal end of the second strap; and
wherein the second strap is configured to engage with the second fixture interface to secure the display device in the display opening on the front face of the theater assembly.

17. The VR headset of claim 16, the second fixture interface includes a buckle rigidly attached to the right wall of the theater assembly, wherein the second strap further includes a second fastening mechanism engagement face on a middle portion of the second strap, and wherein the second strap is configured to be threaded through the buckle and the second fastening mechanism on the distal end of the second strap is configured to be detachably attached to the second fastening mechanism engagement face on the middle portion of the second strap to secure the display device in the display opening on the front face of the theater assembly.

18. A virtual reality (VR) headset comprising:
a theater assembly including:
a display opening on a front face of the theater assembly;
a buckle rigidly attached to a top wall of the theater assembly; and
a strap attached to a bottom wall of the theater assembly, the strap including:
a hook fastening interface on a distal end of the strap; and
a loop fastening interface on a middle portion of the strap; and
wherein the strap is configured to be threaded through the buckle and the hook fastening interface on the distal end of the strap is configured to be detachably attached to the loop fastening interface on the middle portion of the strap to secure a display device in the display opening on the front face of the theater assembly.

19. A virtual reality (VR) headset comprising:
a theater assembly including:
a display opening on a front face of the theater assembly;
a loop fastening interface attached to a top wall of the theater assembly; and
a strap attached to a bottom wall of the theater assembly, the strap including:
a hook fastening interface on a distal end of the strap; and
wherein the strap is configured to be extended over the top wall of the theater assembly and the hook fastening interface on the distal end of the strap is configured to be detachably attached to the loop fastening interface to secure adisplay device in the display opening on the front face of the theater assembly.

20. A virtual reality (VR) headset comprising:
a theater assembly including:
a display opening on a front face of the theater assembly;
a first attachment protrusion and a second attachment protrusion attached to a top wall of the theater assembly; and
a strap attached to a bottom wall of the theater assembly, the strap including:
one or more fastening mechanisms on a distal end of the strap, each of the one or more fastening mechanisms including a first attachment hole and a second attachment hole; and
wherein the strap is configured to be extended over the top wall of the theater assembly and the first attachment hole is configured to be detachably attached to the first attachment protrusion and the second attachment hole is configured to be detachably attached to the second attachment protrusion to secure adisplay device in the display opening on the front face of the theater assembly.
